(19) United States
(12) Patent Application Publication
(10) Pub. No.: US 2003/0052973 A1
(43) Pub. Date: Mar. 20, 2003

(54) Color imaging unit, optical filter of color imaging unit, and interchangeable lens of color imaging unit

(75) Inventor: Hideo Hoshuyama, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/222,926

(22) Filed: Aug. 19, 2002

(30) Foreign Application Priority Data
Sep. 20, 2001 (JP) 2001-286962

(51) Int. Cl. H04N 5/225

(52) U.S. Cl. 348/207.99

(57) ABSTRACT

The invention easily and surely enhances color reproducibility of a color imaging unit. The color imaging unit of the invention includes a color image sensor which has a plurality of types of light receiving parts having different spectral sensitivity characteristics from one another and detecting a visible image of a photographic subject formed by a photographic optical system, and it also includes an optical unit which is inserted into an optical flux incident on the color image sensor and reduces the intensity of light with a specific wavelength within a visible range of the optical flux. If an appropriate specific wavelength is selected, the spectral sensitivity characteristics of the color imaging unit approximate the spectral sensitivity characteristics of the human eye. In other words, this color imaging unit achieves high color reproducibility.

### BACKGROUND OF THE INVENTION

1. Field of the Invention

The present invention relates to a color imaging unit such as an electronic camera or a video camera, an optical filter of the color imaging unit, and an interchangeable lens of the color imaging unit.

2. Description of the Related Art

A color image sensor provided inside an electronic camera has a color filter array disposed on light incident surface side thereof. In the color filter array, three kinds of filters corresponding to three color components of an R (red) color, a G (green) color, and a B (blue) color are repeatedly arranged in order. Each pixel of the color image sensor is given a spectral sensitivity characteristic such that it responds only to any of the color components of the R color, the G color, and the B color.

Incidentally, of output signals (respective signals of the color components) of each pixel output of the color image sensor, a signal of a lacking color component is generated by interpolation (color interpolation) according to an output signal of an adjacent pixel. Thereby, a signal of the R color component, a signal of the B color component, and a signal of the G color component (so-called color signals) of each pixel are generated.

FIG. 13 is a view showing a spectral sensitivity characteristic of an imaging system of an electronic camera which is presently in practical use.

Here, the imaging system refers to an entire optical system from a photographic lens to a color image sensor (a photographic lens, an infrared protection filter, an optical lowpass filter, a color image sensor, and so on).

Therefore, the spectral sensitivity characteristic of the imaging system is determined by a spectral transmittance of the photographic lens, a spectral transmittance of the infrared protection filter, a spectral transmittance of the optical lowpass filter, and a spectral sensitivity characteristic of the image sensor.

In FIG. 13, R is a spectral sensitivity characteristic curve of the R color component (hereinafter, referred to as an ‘R-characteristic curve’), G is a spectral sensitivity characteristic curve of the G color component (hereinafter, referred to as a ‘G-characteristic curve’), and B is a spectral sensitivity characteristic curve of the B color component (hereinafter, referred to as a ‘B-characteristic curve’).

In order for the electronic camera to have high color reproducibility, its spectral sensitivity characteristic needs to be similar to a generally known spectral sensitivity characteristic that the human eye normally has (hereinafter, referred to as a ‘spectral sensitivity characteristics of the human eye’).

As shown in FIG. 13, however, the imaging system of the conventional electronic camera has large overlap areas of the B-characteristic curve and the G-characteristic curve and of the G-characteristic curve and the R-characteristic curve compared with the spectral sensitivity characteristics of the human eye. Consequently, there occurs a possibility that a photographic subject may be reproduced with a lower chroma than its actual chroma.

Inside the electronic camera, a signal processing circuit for performing color correction processing (color correction circuit) is provided at a subsequent stage of a circuit for performing the aforesaid color interpolation (color interpolation circuit).

The color correction processing, however, is ‘amplifying color signals’, therefore it leads to decreasing an S/N ratio. Even with an enhanced chroma of a certain photographic subject, the hue of the photographic subject may possibly be greatly different from its actual hue.

Moreover, the color correction processing is generally simple linear transformation processing in the electronic camera in order to suppress the scale of the color correction circuit. Therefore, appropriate processing for a color signal of one color may possibly be inappropriate for a color signal of another color. This makes it impossible to enhance the color reproducibility for all colors.

Because of this, conventionally it is necessary to endure the decrease in the S/N ratio and the increase in the circuit scale in order to achieve high color reproducibility.

Incidentally, to improve the spectral sensitivity characteristic of the imaging system of the electronic camera (refer to FIG. 13), there is an available method for selecting appropriate materials of the three kinds of the filters of the color filter arrays. It is, however, very difficult to reduce the overlap areas of the spectral sensitivity characteristic curves by this method.

### SUMMARY OF THE INVENTION

It is an object of the present invention to provide a color imaging unit which achieves high color reproducibility with simplicity and reliability.

It is another object of the present invention to provide an optical filter of the color imaging unit which can easily and surely give high color reproducibility to the color imaging unit.

It is still another object of the present invention to provide an interchangeable lens of the color imaging unit which can easily and surely give high color reproducibility to the color imaging unit.

In order to attain the above-described object, a color imaging unit of the present invention comprises: a color image sensor having a plurality of types of light receiving parts which have different spectral sensitivity characteristics from one another and detect a visible image of a photographic subject formed by a photographic optical system; and an optical unit which is inserted into an optical flux incident on the color image sensor and reduces an intensity of light with a specific wavelength which is within a visible range of the optical flux.

If a specific wavelength having an appropriate value is selected, the spectral sensitivity characteristics of the color imaging unit approximate to the spectral sensitivity characteristics of the human eye. In other words, this color imaging unit achieves high color reproducibility.

Preferably, the specific wavelength is a wavelength within a wavelength range which the light receiving parts of the color image sensor can commonly detect. When the specific wavelength is set to such a value, the spectral sensitivity characteristics of the color imaging unit approximate to the spectral sensitivity characteristics of the human eye. Further, the specific wavelength is preferably a wavelength within a wavelength range of 480 nm to 520 nm.

If a conventional color image sensor is used as the aforesaid color image sensor, an overlap area of a B-characteristic curve and a G-characteristic curve as the spectral sensitivity characteristics of the color imaging unit is reduced to be small.

Further, the specific wavelength is preferably a wavelength within a wavelength range of 580 nm to 620 nm.

If the conventional color image sensor is used as the aforesaid color image sensor, an overlap area of the G-characteristic curve and an R-characteristic curve as the spectral sensitivity characteristics of the color imaging unit is reduced to be small.

Further, there can be two specific wavelengths which are preferably a wavelength within a wavelength range of 480 nm to 520 nm and a wavelength within a wavelength range of 580 nm to 620 nm.

If the conventional color image sensor is used as the aforesaid color image sensor, the overlap area of the B-characteristic curve and the G-characteristic curve as the spectral sensitivity characteristics of the color imaging unit is reduced to be small, and so is the overlap area of the G-characteristic curve and the R-characteristic curve.

Further, the optical unit is preferably made of a thin film formed on an optically protective glass of the color image sensor. The optical unit is also preferably made of a thin film formed on a photographic subject side surface of the photographic optical system.

Forming the optical unit on the photographic subject side surface eliminates the possibility that an excessive reflective light becomes a stray light in the color imaging unit since it is directed toward the photographic subject side, even when a reflection of light is used to reduce the intensity of the light with the specific wavelength.

Next, in order to attain another one of the above-described objects, an optical filter of the present invention is applied to a color imaging unit comprising a color image sensor which has a plurality of types of light receiving parts having different spectral sensitivity characteristics from one another and detecting a visible image of a photographic subject formed by a photographic optical system, and the optical filter is also insertable into an optical flux incident on the color image sensor and reduces an intensity of light with a specific wavelength which is within a visible range of the optical flux.

When a specific wavelength having an appropriate value is selected, the spectral sensitivity characteristics of the color imaging unit approximate to the spectral sensitivity characteristics of the human eye. In other words, the optical filter of this color imaging unit gives high color reproducibility to the color imaging unit easily and surely.

Preferably, the specific wavelength is a wavelength within a wavelength range which is commonly detectable by the plurality of types of light receiving parts of the color image sensor.

When the specific wavelength is set at such a value, the spectral sensitivity characteristics of the color imaging unit approximate to the spectral sensitivity characteristics of the human eye.

Further, the specific wavelength is preferably a wavelength within a wavelength range of 480 nm to 520 nm.

If a conventional color image sensor is used as the aforesaid color image sensor, an overlap area of a B-characteristic curve and a G-characteristic curve as the spectral sensitivity characteristics of the color imaging unit is reduced to be small.

Further, the specific wavelength is preferably a wavelength within a wavelength range of 580 nm to 620 nm.

If the conventional color image sensor is used as the aforesaid color image sensor, an overlap area of the G-characteristic curve and an R-characteristic curve as the spectral sensitivity characteristics of the color imaging unit is reduced to have a small value.

Further, there can be two specific wavelengths; preferably a wavelength within a wavelength range of 480 nm to 520 nm and a wavelength within a wavelength range of 580 nm to 620 nm.

If the conventional color image sensor is used as the aforesaid color image sensor, the overlap area of the B-characteristic curve and the G-characteristic curve as the spectral sensitivity characteristics of the color imaging unit is reduced to be small, and so is the overlap area of the G-characteristic curve and the R-characteristic curve.

Next, in order to attain the above-described objects, an interchangeable lens of the present invention is applied to a color imaging unit comprising a color image sensor which has a plurality of types of light receiving parts having different spectral sensitivity characteristics from one another and detecting a visible image of a photographic subject, and the interchangeable lens comprises a photographic optical system forming an image of the photographic subject on the color image sensor and an optical unit which is inserted into an optical flux incident on the color image sensor and reduces an intensity of light with a specific wavelength within a visible range of the optical flux.

When a specific wavelength having an appropriate value is selected, the spectral sensitivity characteristics of the color imaging unit approximate to the spectral sensitivity characteristics of the human eye. In other words, the interchangeable lens of this color imaging unit gives high color reproducibility to the color imagining unit easily and surely.

Preferably, the specific wavelength is a wavelength within a wavelength range which is commonly detectable by the plurality of types of the light receiving parts of the color image sensor.

When the specific wavelength is set to such a value, the spectral sensitivity characteristics of the color imaging unit approximate to the spectral sensitivity characteristics of the human eye.

In the interchangeable lens of the color imagining unit the specific wavelength is preferably a wavelength within a wavelength range of 480 nm to 520 nm.

If a conventional color image sensor is used as the aforesaid color image sensor, an overlap area of a B-characteristic curve and a G-characteristic curve as the spectral sensitivity characteristics of the color imaging unit is reduced to be small.

Further, the specific wavelength is preferably a wavelength within a wavelength range of 580 nm to 620 nm.

If the conventional color image sensor is used as the aforesaid color image sensor, an overlap area of the G-characteristic curve and an R-characteristic curve as the spectral sensitivity characteristics of the color imaging unit is reduced to be small.

Further, the specific wavelength is preferably a specific wavelength within a wavelength range of 480 nm to 520 nm and a wavelength within a wavelength range of 580 nm to 620 nm.

If the conventional color image sensor is used as the aforesaid color image sensor, the overlap area of the B-characteristic curve and the G-characteristic curve as the spectral sensitivity characteristics of the color imaging unit is reduced to be small, and so is the overlap area of the G-characteristic curve and the R-characteristic curve.

Further, the optical unit is preferably made of a thin film formed on a photographic subject side surface of the photographic optical system. Forming the optical unit on the photographic subject side surface eliminates the possibility that an excessive reflective light becomes a stray light in the color imaging unit since it is directed toward the photographic subject, even when a reflection of light is used to reduce the intensity of the light with the specific wavelength.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 illustrates the configuration of an electronic camera 1;

FIG. 2 illustrates an imaging system of the electronic camera 1 of a first embodiment;

FIG. 3 shows a spectral transmission characteristic of a BG color-segregating film;

FIG. 4 shows a spectral sensitivity characteristic of the imaging system of the electronic camera 1 of the first embodiment;

FIG. 5 illustrates an imaging system of an electronic camera 1 of a second embodiment;

FIG. 6 shows a spectral transmission characteristic of a BG/GR color-segregating film;

FIG. 7 shows a spectral sensitivity characteristic of the imaging system of the electronic camera 1 of the second embodiment;

FIG. 8 illustrates an imaging system of an electronic camera 1 of a third embodiment;

FIG. 9(a) shows a spectral transmission characteristic of a BG color-segregating film; FIG. 9(b) shows a spectral transmission characteristic of a GR color-segregating film;

FIG. 10 illustrates an imaging system of an electronic camera 1 of a fourth embodiment;

FIG. 11 shows a spectral sensitivity characteristic of the imaging system of the electronic camera 1 of the fourth embodiment;

FIG. 12 illustrates an electronic camera system of a fifth embodiment; and

FIG. 13 shows a spectral sensitivity characteristic of an imaging system of a conventional electronic camera.

### DESCRIPTION OF THE PREFERRED EMBODIMENTS

Embodiments of the present invention will be explained below with reference to the drawings.

<First Embodiment>

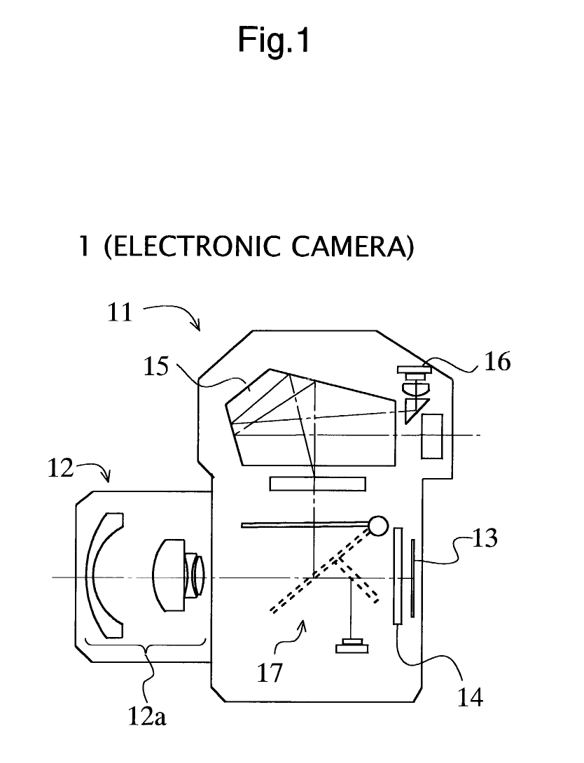

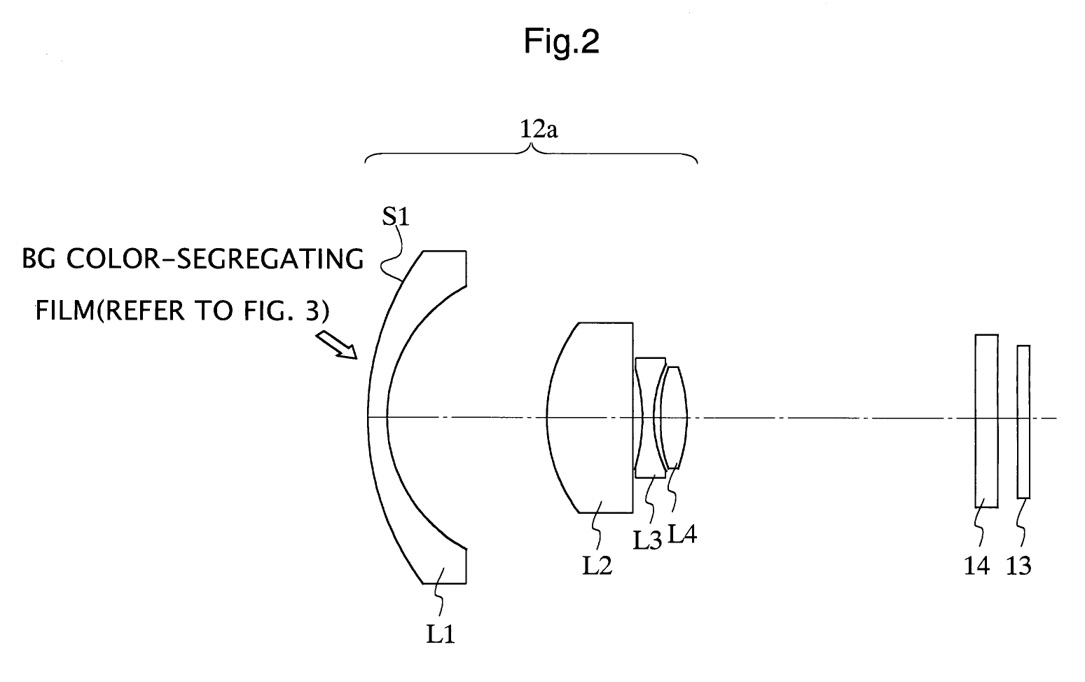

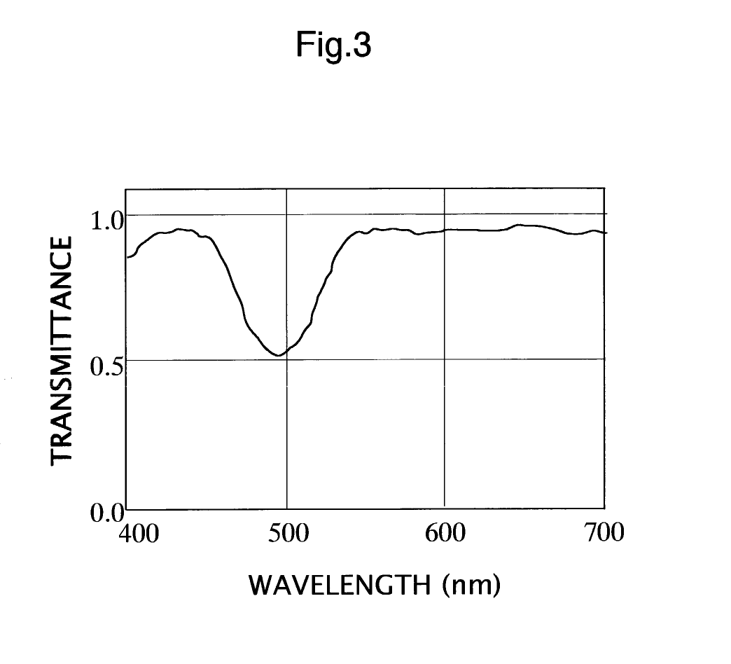

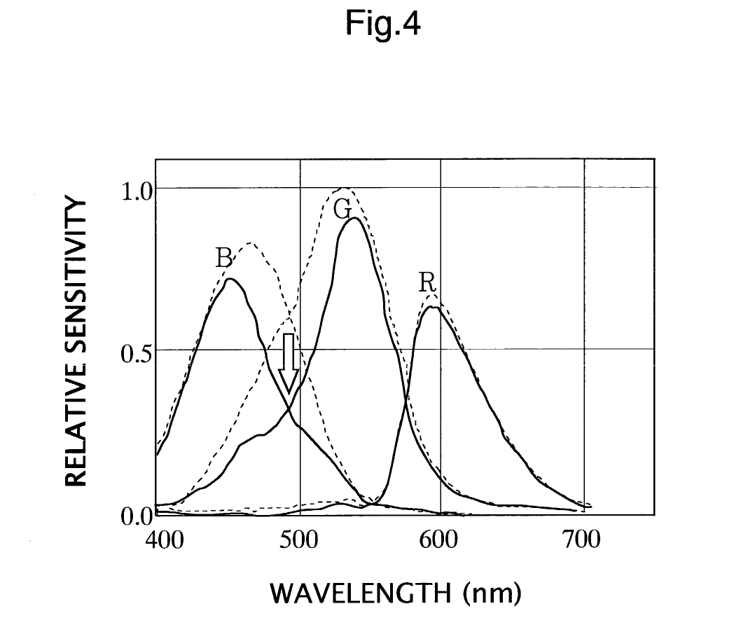

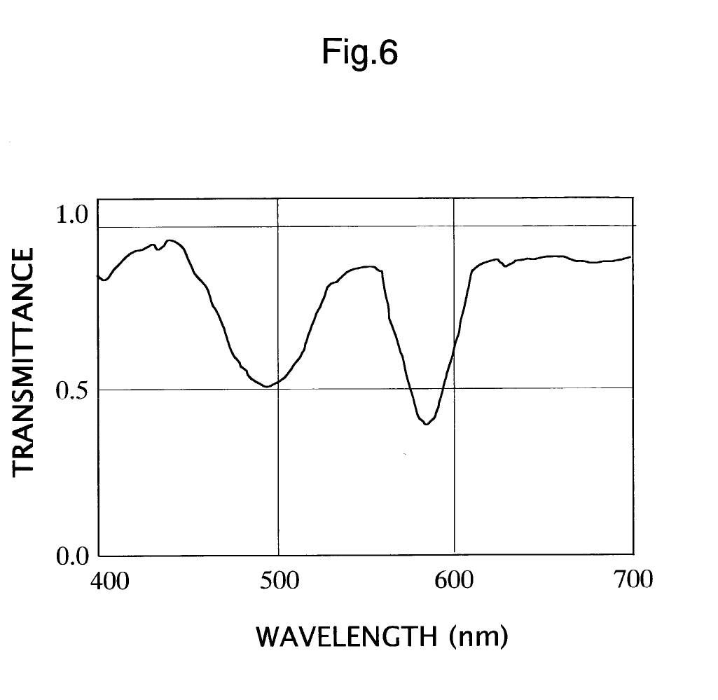

A first embodiment of the present invention will be explained with reference to FIG. 1, FIG. 2, FIG. 3, FIG. 4, and FIG. 6.

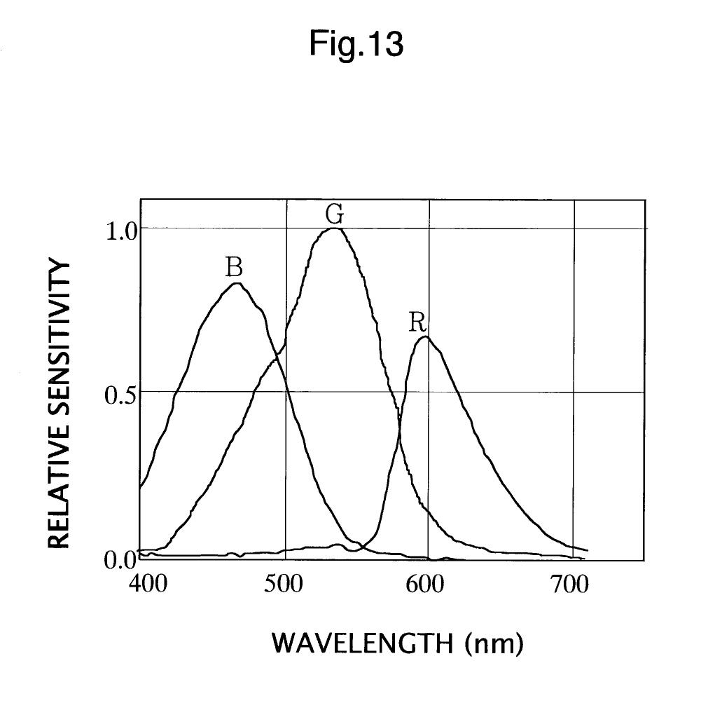

In order to improve a spectral sensitivity characteristic of an imaging system of an electronic camera (refer to FIG. 13), the inventors of the present invention have thought of positively attenuating light with a specific wavelength by adding a new optical unit, not by appropriately selecting respective materials of three kinds of filters of a color filter array.

When this specific wavelength is set to an appropriate value, the spectral sensitivity characteristic of the imaging system (refer to FIG. 13) can approximate to a spectral sensitivity characteristics of the human eye. Specific explanation will be given below.

FIG. 1 is a view explaining the configuration of an electronic camera 1.

The electronic camera 1 of this embodiment comprises a color image sensor 13 similarly to a conventional electronic camera. The color image sensor 13 has a color filter array (not shown) on a front surface thereof.

Incidentally, the electronic camera 1 shown in FIG. 1 is an interchangeable type lens composed of an electronic camera body 11 and an interchangeable lens 12, but it may be an integrated type (in the following it is assumed to be the interchangeable type lens).

Here, a photographic optical system 12a inside the interchangeable lens 12, the color image sensor 13 inside the electronic camera body 11, and an optically protective glass 14 of the color image sensor 13 compose an imaging system of the electronic camera 1.

FIG. 2 is a view explaining the imaging system of the electronic camera 1 of this embodiment.

In the photographic optical system 12a, a plurality of lenses, for example lenses L1, L2, L3, and L4 are arranged in the order from a photographic subject side. The color image sensor 13 is disposed near an image plane of the photographic optical system 12a. The optically protective glass 14 is disposed on a front surface of the color image sensor 13 (on a photographic optical system 12a side).

In the optically protective glass 14, an optical filter including an infrared protection filter, an optical lowpass filter, and so on are formed.

As seen from the above, the configuration of the imaging system of the electronic camera 1 of this embodiment is not at all different from the configuration of an imaging system of the conventional electronic camera.

In the electronic camera 1 of this embodiment, however, a BG color-segregating film having a predetermined spectral transmission characteristic is formed on the most photographic subject side surface of the imaging system (namely, on the photographic subject side surface S1 of the lens L1).

The BG color-segregating film is, for example, an optical thin film which reflects light in a predetermined wavelength range. The optical thin film is formed on the lens L1 by deposition.

FIG. 3 is a view showing a spectral transmission characteristic of the BG color-segregating film.

As is apparent from FIG. 3, this spectral transmission characteristic reduces the intensity of light with a specific wavelength within a visible range (400 nm to 700 nm) of an optical flux incident on the color image sensor 13.

This specific wavelength is a wavelength within a wavelength range of 480 nm to 520 nm. In FIG. 3, the intensity of light with a wavelength of 490 nm is reduced most.

As described above, the spectral transmission characteristic of the BG color-segregating film has a negative peak (valley) at a wavelength which corresponds to a substantially intermediate color of a B color and a G color. In other words, the spectral transmission characteristic depicts a ‘V-shaped curve’.

FIG. 4 is a view showing a spectral sensitivity characteristic of the imaging system of the electronic camera 1 of this embodiment.

In FIG. 4, dotted lines show a spectral sensitivity characteristic of the conventional imaging system, and solid lines show the spectral sensitivity characteristic of the imaging system of this embodiment.

As a result of forming the BG color-segregating film, an overlap area of a B-characteristic curve and a G-characteristic curve becomes small.

In other words, the spectral sensitivity characteristics of the imaging system approximate the spectral sensitivity characteristics of the human eye.

Furthermore, the formation of the BG color-segregation film causes a peak wavelength of the B-characteristic curve to shift from 465 nm to 450 nm, and a peak wavelength of the G-characteristic curve to shift from 530 nm to 540 nm.

Owing to these shifts, the spectral sensitivity characteristics of the imaging system further approximate the spectral sensitivity characteristics of the human eye.

In this embodiment described above, the high color reproducibility is surely obtained (refer to FIG. 4) since the BG color-segregating film (refer to FIG. 3) is formed in the imaging system of the conventional electronic camera.

Further, in this embodiment, the BG color-segregating film is formed inside the interchangeable lens 12 but the electronic camera body 11 may be the same as a body of the conventional electronic camera.

Incidentally, in this embodiment, using the optical thin film as the BG color-segregating film is most convenient because giving a desired spectral transmission characteristic to the optical thin film is easily realized by a film structure design (generally known) of the optical thin film.

Here, the optical thin film also has a disadvantage that its spectral transmission characteristic generally depends on an incident angle of light.

In this embodiment, however, since the BG color segregating film is formed on the lens surface (namely, a pupil surface), an input/output characteristic of each optical flux incident on the color image sensor 13 (namely, the image plane) is made uniform thereon. Consequently, the electronic camera 1 can obtain a color-reproduced image with a uniform color reproducibility.

Further, the use of the optical thin film having reflection (effect of reflecting light with a specific wavelength) generally causes occurrence of a stray light inside the imaging system due to a reflective light occurring on this optical thin film, which may possibly cause a flare and a ghost image on the color-reproduced image.

In this embodiment, however, the BG color-segregating film is formed on the most photographic subject side surface of the imaging system, by which reduces the possibility of causing the stray light inside the imaging system.

<Second Embodiment>

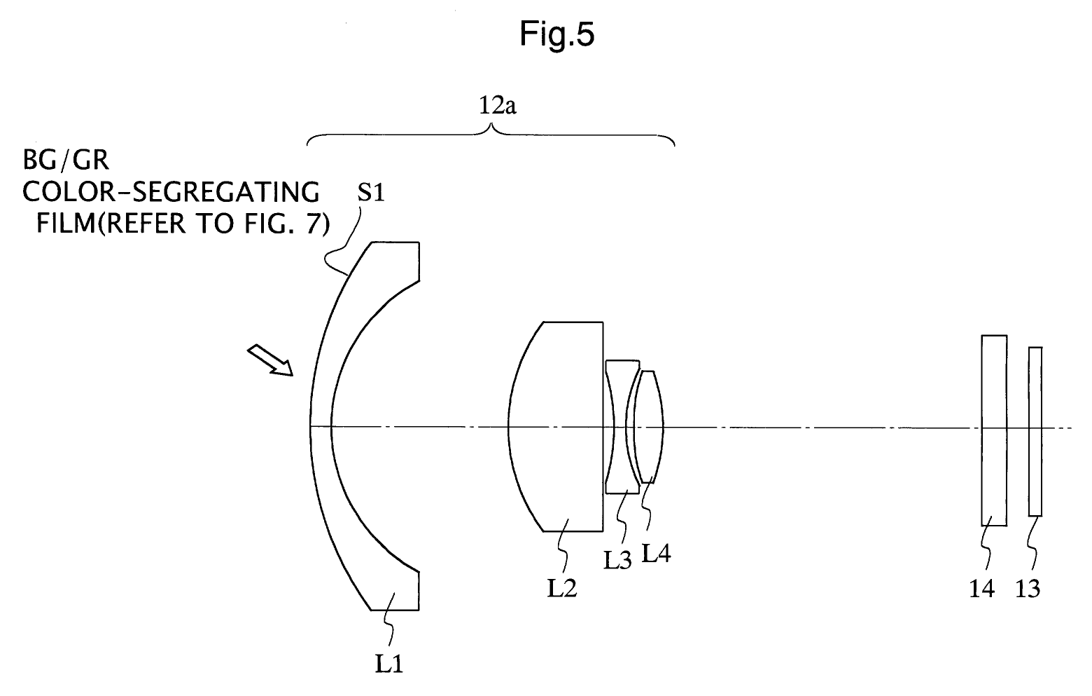

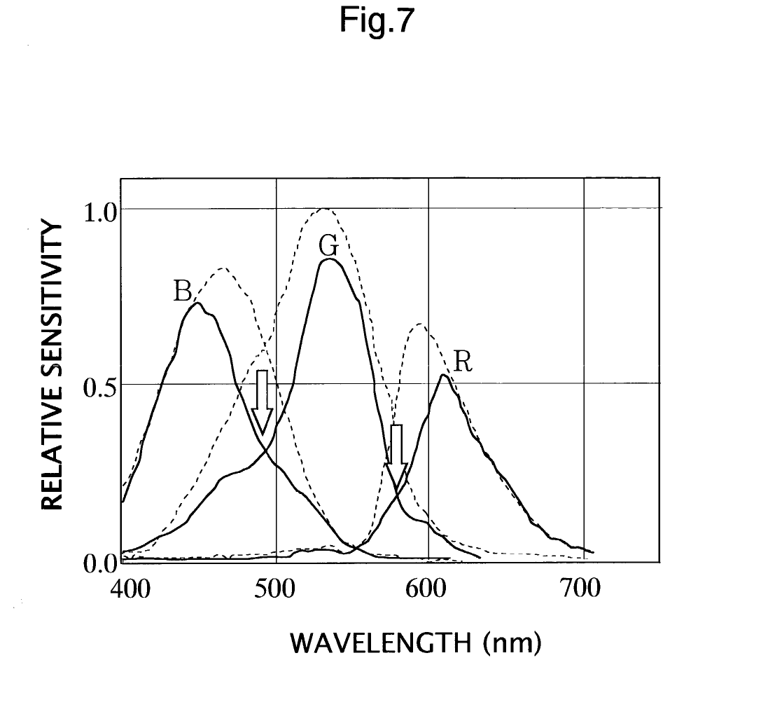

A second embodiment of the present invention will be explained with reference to FIG. 5, FIG. 6, and FIG. 7. Note that only the differences from the first embodiment will be explained here.

FIG. 5 is a view explaining an imaging system of an electronic camera 1 of this embodiment.

In the imaging system of the electronic camera 1 of this embodiment, a BG/GR color-segregating film having a spectral transmission characteristic as shown in FIG. 6 is formed instead of the BG color-segregating film. The forming position of this BG/GR color-segregating film is on a surface SI, which is the same as that of the BG color-segregating film in the first embodiment.

As is apparent from FIG. 6, the spectral transmission characteristic of the BG/GR color-segregating film reduces the intensity of light with a specific wavelength within a visible range (400 nm to 700 nm) of an optical flux incident on a color image sensor 13.

This BG/GR color-segregating film is, for example, an optical thin film which reflects light in a predetermined wavelength range.

Incidentally, in this embodiment, there are two specific wavelengths. The specific wavelengths are a wavelength within a wavelength range of 480 nm to 520 nm and a wavelength within a wavelength range of 580 nm to 620 nm. Especially in FIG. 6, mainly reduced are the intensities of light with a wavelength of 490 nm and of light with a wavelength of 585 nm.

As described above, the spectral transmission characteristic of the BG/GR color-segregating film has a negative peak (valley) at a wavelength corresponding to a substantially intermediate color between a B color and a G color and at a wavelength corresponding to a substantially intermediate color between the G color and an R color. In other words, the spectral transmission characteristic depicts a ‘W-shaped curve’.

FIG. 7 is a view showing a spectral sensitivity characteristic of the imaging system of the electronic camera 1 of this embodiment.

In FIG. 7, dotted lines show the spectral sensitivity characteristic of the conventional imaging system, and solid lines show the spectral sensitivity characteristic of the imaging system of this embodiment.

As a result of forming the BG/GR color-segregating film, an overlap area of a B-characteristic curve and a G-characteristic curve and an overlap area of the G-characteristic curve and an R-characteristic curve become small.

In other words, the spectral sensitivity characteristics of the imaging system approximate the spectral sensitivity characteristics of the human eye (approximates more than that of the first embodiment does).

Furthermore, the formation of the BG/GR color-segregation film causes a peak wavelength of the B-characteristic curve to shift from 465 nm to 450 nm, a peak wavelength of the G-characteristic curve to shift from 530 nm to 540 nm, and a peak wavelength of the R-characteristic curve to shift from 595 nm to 610 nm.

Owing to these shifts, the spectral sensitivity characteristics of the imaging system further approximate the spectral sensitivity characteristics of the human eye.

In this embodiment described above, the high color reproducibility is surely obtained (refer to FIG. 7) since the BG/GR color-segregating film (refer to FIG. 6) is formed in the imaging system of the conventional electronic camera.

In this embodiment, the BG/GR color-segregating film is formed inside an interchangeable lens 12 but an electronic camera body 11 may be the same as a body of the conventional electronic camera.

Incidentally, in this embodiment, using the optical thin film as the BG/GR color-segregating film is most convenient because giving a desired spectral transmission characteristic to the optical thin film is easily realized by a film structure design (generally known) of the optical thin film.

Here, the optical thin film also has a disadvantage that its spectral transmission characteristic generally depends on an incident angle of light.

In this embodiment, however, the BG/GR color segregating film is formed on the lens surface (namely, a pupil surface) so that an input/output characteristic of each optical flux incident on the color image sensor 13 (namely, an image plane) is made uniform thereon. Consequently, the electronic camera 1 can obtain a color-reproduced image with a uniform color reproducibility.

Further, the use of the optical thin film having reflection (effect of reflecting light with a specific wavelength) generally causes occurrence of a stray light inside the imaging system due to a reflective light occurring on this optical thin film, which may possibly cause a flare and a ghost image on the color-reproduced image.

In this embodiment, however, the BG/GR color-segregating film is formed on the most photographic subject side surface of the imaging system, which reduces the possibility of causing the stray light inside the imaging system.

<Third Embodiment>

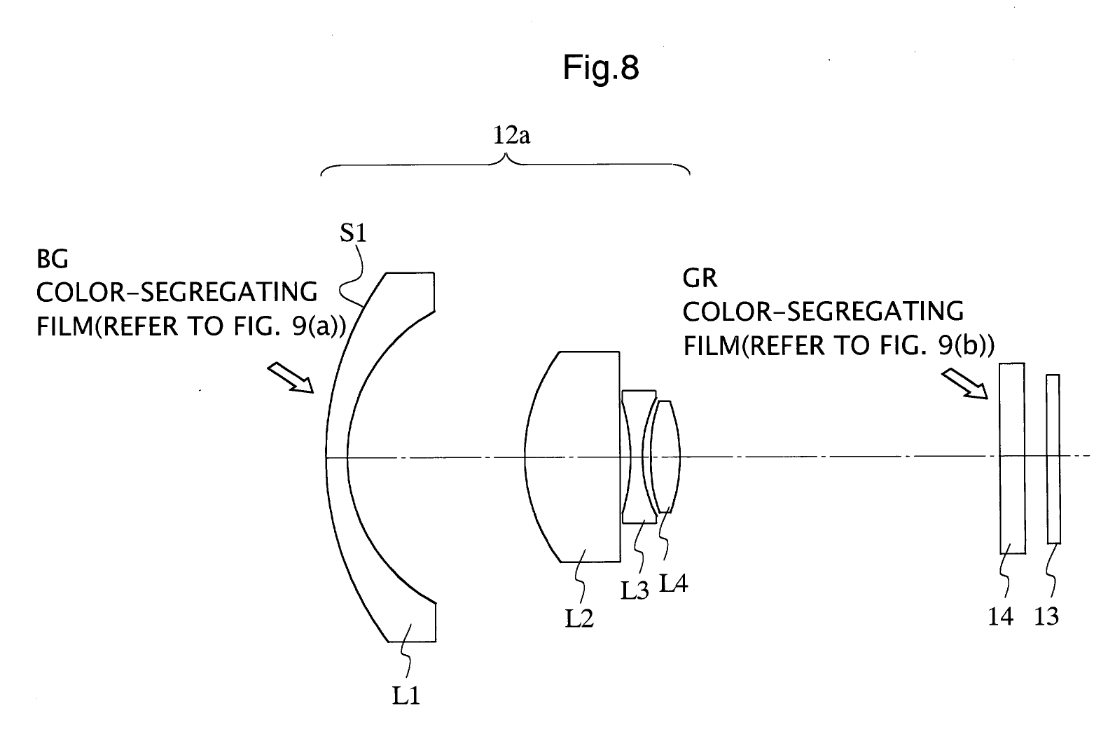

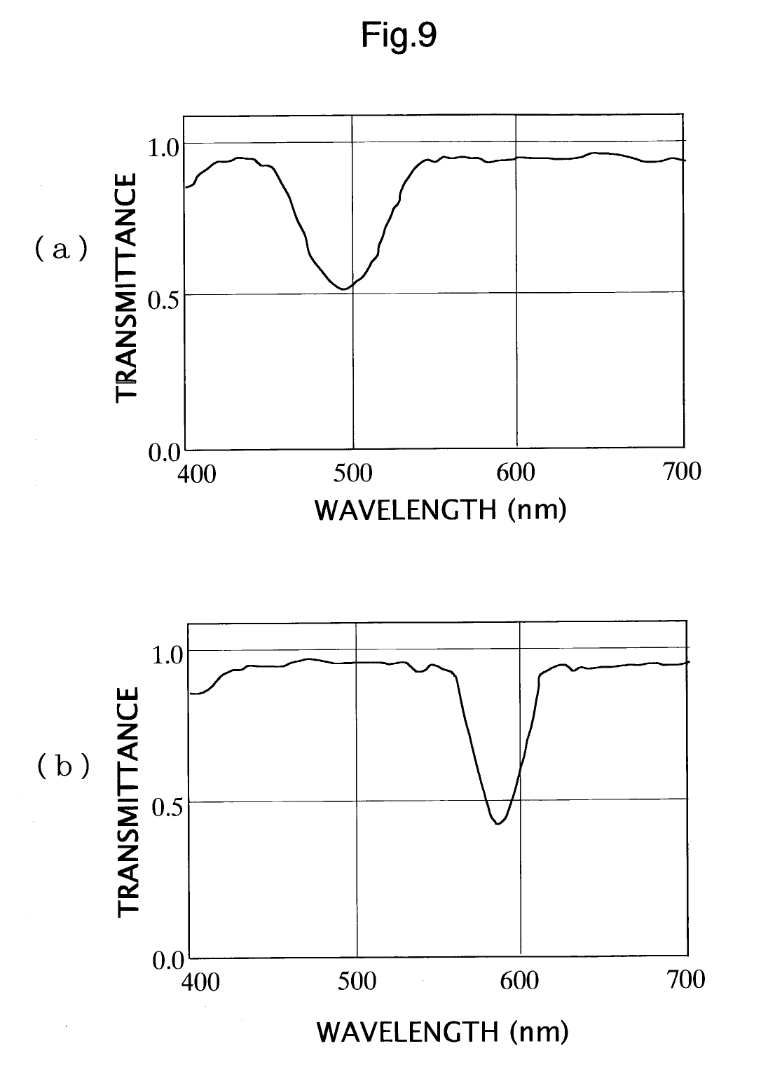

A third embodiment of the present invention will be explained with reference to FIG. 8 and FIG. 9. Note that only the differences from the first embodiment will be explained here.

FIG. 8 is a view explaining an imaging system of an electronic camera 1 of this embodiment.

In the imaging system of the electronic camera 1 of this embodiment, a GR color-segregating film having a spectral transmission characteristic as shown in FIG. 9(b) is formed in addition to the BG color-segregating film. The forming position of this GR color-segregating film is on an optically protective glass (consisting of a plurality of layers as is previously described) 14 of a color image sensor 13.

This GR color-segregating film is, for example, an optical thin film which reflects light in a predetermined wavelength range.

Incidentally, the forming position of this GR color-segregating film in the optically protective glass 14 may be on any of a photographic subject side surface of the optically protective glass 14, a color image sensor 13 side surface of the optically protective glass 14, and an inner layer of the optically protective glass 14.

Note that FIG. 9(a) is a view showing a spectral transmission characteristic of the BG color-segregating film. The explanation on the BG color-segregating film is the same as that in the first embodiment.

Further, as is shown in FIG. 9(b), the spectral transmission characteristic of the GR color-segregating film reduces the intensity of light with a specific wavelength within a visible range (400 nm to 700 nm) of an optical flux incident on the color image sensor 13. Note that the specific wavelength is a wavelength within a wavelength range of 580 nm to 620 nm. In FIG. 9(b), the intensity of light with a wavelength of 585 nm is reduced especially.

Incidentally, the spectral transmission characteristic of the GR color-segregating film reaches a negative peak (valley) at 585 nm. In other words, the spectral transmission characteristic depicts a ‘V-shaped curve’.

Since the two color-segregating films (the BG color-segregating film and the GR color-segregating film) described above serve substantially the same function as that of the BG/GR color-segregating film of the second embodiment, a spectral sensitivity characteristic of the imaging system of this embodiment is substantially the same as the spectral sensitivity characteristic of the imaging system of the second embodiment (refer to FIG. 7).

In this embodiment, it is most convenient to use the optical thin film for at least one of the BG color-segregating film and the GR color-segregating film. This is because giving a desired spectral transmission characteristic to the optical thin film is easily realized by a film structure design (generally known) of the optical thin film.

<Fourth Embodiment>

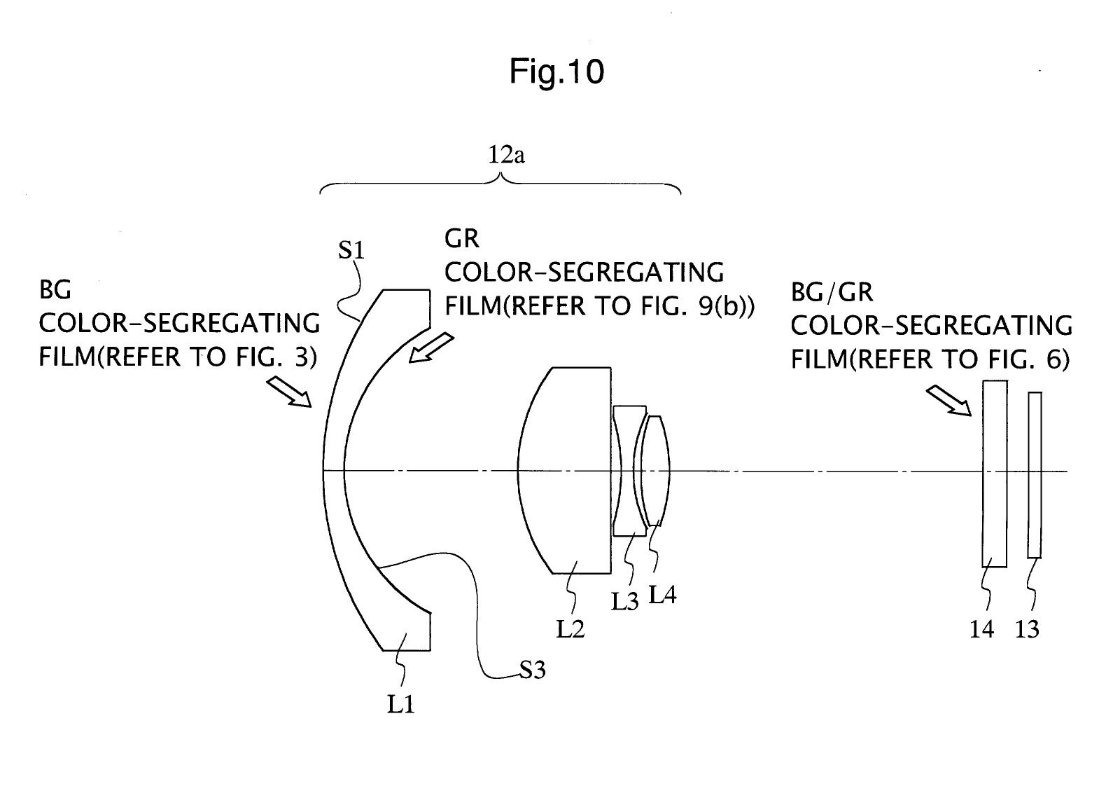

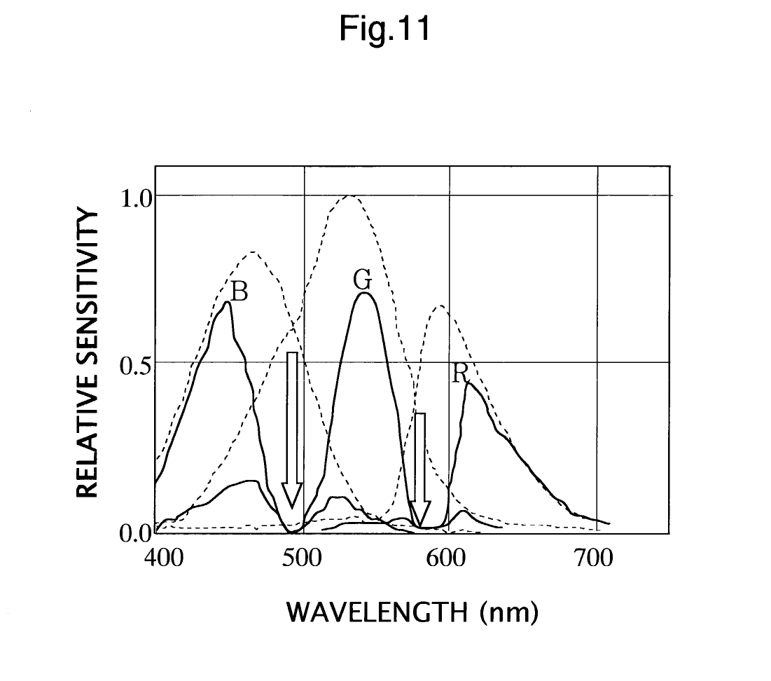

A fourth embodiment of the present invention will be explained with reference to FIG. 10 and FIG. 11. Note that only the differences from the first embodiment will be explained here.

FIG. 10 is a view explaining an imaging system of an electronic camera 1 of this embodiment.

In the imaging system of this embodiment, a GR color-segregating film (refer to FIG. 9(b)) is formed on an image plane side S3 of a lens L1 in addition to the BG color-segregating film. Moreover, a BG/GR color-segregating film (refer to FIG. 6) is formed on an optically protective glass 14 of a color image sensor 13.

FIG. 11 is a view showing a spectral sensitivity characteristic of the imaging system of the electronic camera 1 of this embodiment.

In FIG. 11, dotted lines show the spectral sensitivity characteristic of the conventional imaging system, and solid lines show the spectral sensitivity characteristic of the imaging system of this embodiment.

As is apparent from FIG. 11, overlap areas of spectral sensitivity characteristic curves of respective color components are also well reduced in this embodiment so that the spectral sensitivity characteristic approximates the spectral sensitivity characteristics of the human eye.

Note that the spectral sensitivity characteristics of the imaging system of this embodiment approximate the spectral sensitivity characteristics of the human eye more than that of each of the above-described embodiments does.

In this embodiment described above, using the BG color-segregating film and the BG/GR color-segregating film together further enhances color reproducibility. The GR color-segregating film and the BG/GR color-segregating film may also be used together, which similarly enhances the color reproducibility.

Incidentally, in this embodiment, it is most convenient to use an optical thin film for at least two of the BG color-segregating film, the GR color-segregating film, and the BG/GR color-segregating film because giving a desired spectral transmission characteristic to the optical thin film is easily realized by a film structure design (generally known) of the optical thin film.

<Supplemental Explanation to the First Embodiment to the Fourth Embodiment>

Here, in each of the above-described embodiments, the color-segregating film is formed inside the interchangeable lens 12. With formation of the same color-segregating film on the optically protective glass 14, modification to a conventional interchangeable lens will not be needed (in other words, the high color reproducibility is attainable by using the conventional interchangeable lens without modification).

Further, in the above-described third embodiment and fourth embodiment, the color-segregating film is formed inside the electronic camera body 11, but the formation of the same color-segregating film on the interchangeable lens 12 side will eliminate the necessity of modifying the conventional electronic camera body (in other words, the conventional electronic camera body is usable as it is in obtaining the high color reproducibility).

Note that generally known film forming techniques are applied to: (1) the adjustment of the spectral transmission characteristic of the color-segregating films; (2) the formation of the color-segregating films on optical elements in various kinds of shapes; (3) the formation of two or more of the color-segregating films on the same optical element; and (4) the formation of the color-segregating film in the inner layer of the optical element.

Further, types and forming positions of the color-segregating film in the imaging system of the electronic camera are preferably selected when needed in response to requests from users and manufacturers. It is also preferable that the spectral transmission characteristic of each of the color-segregating films be precisely set, when needed, in conformity with its forming position, the spectral sensitivity characteristic peculiar to the color image sensor 13, and so on.

<Fifth Embodiment>

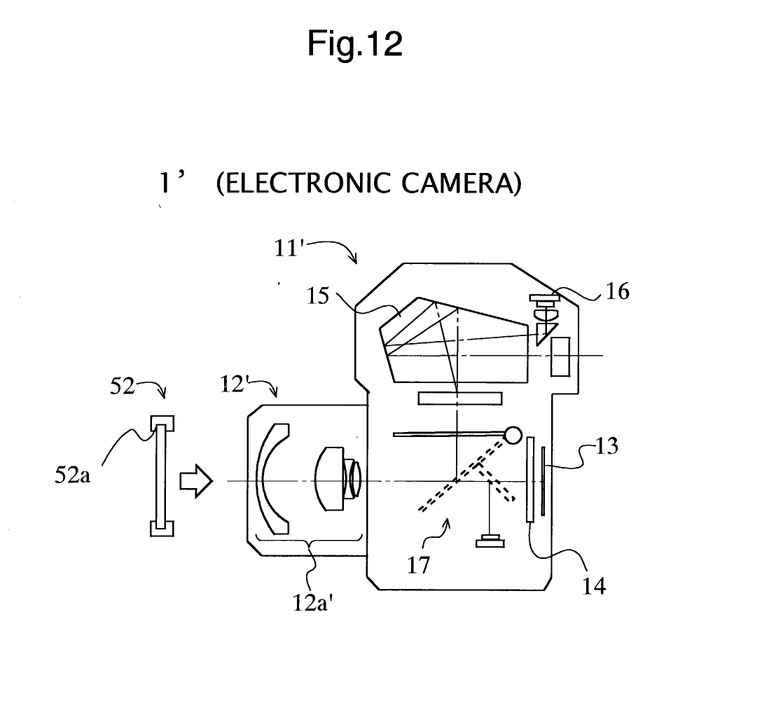

A fifth embodiment of the present invention will be explained with reference to FIG. 12.

FIG. 12 is a view explaining an electronic camera system of this embodiment.

What is explained in this embodiment is a camera system composed of an electronic camera 1′ and a color-segregating filter 52.

The color-segregating filter 52 has at least one color segregating film among the BG color-segregating film (refer to FIG. 3 and FIG. 9(a)), the BG/GR color-segregating film (refer to FIG. 6), and the GR color-segregating film (refer to FIG. 9(b)), which were explained in each of the above-described embodiments, formed on a transparent substrate (for example, a transparent glass).

This color-segregating filter 52 is attachable/detachable to/from some position (for example, an interchangeable lens 12′ side closest to a photographic subject) of an imaging system of the electronic camera 1′.

The color-segregating filter 52 is sandwiched by ring-shaped supporting members 52a, for example, from a circumferential periphery thereof. The color-segregating filter 52 is attached/detached to/from a lens barrel of the imaging system of the electronic camera 1′ via the supporting members 52a.

Incidentally, the essential configuration of the electronic camera 1′ may be the same as the conventional electronic camera, but a part (not shown) for catching the supporting members 52a is formed at least in a place to which this color-segregating filter 52 is inserted. This color-segregating filter 52 gives a high color reproducibility to the imaging system of the electronic camera 1′ the same as each of the color-segregating films explained in each of the above-described embodiments.

Further, the use of the color-segregating filter 52 in this embodiment allows the use of the conventional electronic camera body and interchangeable lens without modification.

<Additional Remarks>

In each of the above-described embodiments, the optical thin film having the reflective effect was described as a way of example of the color-segregating film, but the color-segregating film may be an optical thin film having absorption (here, especially an effect of absorbing light having a predetermined wavelength range). Moreover, as long as it has the above-described spectral transmission characteristic, it need not be a thin film, but may be an optical element having a certain thickness.

In the above-described embodiments, the electronic camera was described, but the present invention is also applicable to other color imaging units (a video camera and so on).

The invention is not limited to the above embodiments and various modifications may be made without departing from the spirit and scope of the invention. Any improvement may be made in part or all of the components.

What is claimed is:

1. A color imaging unit, comprising:
a color image sensor having light receiving parts of a plurality of types which have different spectral sensitivity characteristics from one another and detect a visible image of a photographic subject, said visible image being formed by a photographic optical system; and
an optical unit inserted into an optical flux incident on said color image sensor, and reducing an intensity of light with specific wavelength(s) which is/are within a visible range of the optical flux.

2. The color imaging unit according to claim 1, wherein
the specific wavelength is a wavelength within a wavelength range which at least two of said light receiving parts are able to detect commonly.

3. The color imaging unit according to claim 1, wherein
the specific wavelength is a wavelength within a wavelength range of 480 nm to 520 nm.

4. The color imaging unit according to claim 1, wherein
the specific wavelength is a wavelength within a wavelength range of 580 nm to 620 nm.

5. The color imaging unit according to claim 1, wherein
the specific wavelengths are a wavelength within a wavelength range of 480 nm to 520 nm and a wavelength within a wavelength range of 580 nm to 620 nm.

6. The color imaging unit according to claim 1, wherein
said optical unit is made of a thin film formed on an optically protective glass of said color image sensor.

7. The color imaging unit according to claim 1, wherein
said optical unit is made of a thin film formed on a photographic subject side surface of the photographic optical system.

8. An optical filter of a color imaging unit, said color imaging unit comprising light receiving parts of a plurality of types which have different spectral sensitivity characteristics from one another and detect a visible image of a photographic subject, said visible image being formed by a photographic optical system, wherein
said optical filter is insertable into an optical flux incident on said color image sensor and reduces an intensity of light with specific wavelength(s) which is/are within a visible range of the optical flux.

9. The optical filter of the color imaging unit according to claim 8, wherein
the specific wavelength is a wavelength within a wavelength range which at least two of said light receiving parts are able to detect commonly.

10. The optical filter of the color imaging unit according to claim 8, wherein
the specific wavelength is a wavelength within a wavelength range of 480 nm to 520 nm.

11. The optical filter of the color imaging unit according to claim 8, wherein
the specific wavelength is a wavelength within a wavelength range of 580 nm to 620 nm.

12. The optical filter of the color imaging unit according to claim 8, wherein
the specific wavelengths are a wavelength within a wavelength range of 480 nm to 520 nm and a wavelength within a wavelength range of 580 nm to 620 nm.

13. An interchangeable lens of a color imaging unit, said color imaging unit comprising a color image sensor having light receiving parts of a plurality of types which have different spectral sensitivity characteristics from one another and detect a visible image of a photographic subject, said visible image being formed by a photographic optical system, said interchangeable lens comprising:
a photographic optical system forming an image of the photographic subject on said color image sensor; and
an optical unit being inserted into an optical flux incident on said color image sensor and reducing an intensity of light with specific wavelength(s) which is/are within a visible range of the optical flux.

14. The interchangeable lens of the color imaging unit according to claim 13, wherein
the specific wavelength is a wavelength within a wavelength range which at least two of said light receiving parts are able to detect commonly.

15. The interchangeable lens of the color imaging unit according to claim 13, wherein
the specific wavelength is a wavelength within a wavelength range of 480 nm to 520 nm.

16. The interchangeable lens of the color imaging unit according to claim 13, wherein
the specific wavelength is a wavelength within a wavelength range of 580 nm to 620 nm.

17. The interchangeable lens of the color imaging unit according to claim 13, wherein
the specific wavelengths are a wavelength within a wavelength range of 480 nm to 520 nm and a wavelength within a wavelength range of 580 nm to 620 nm.

18. The interchangeable lens of the color imaging unit according to claim 13, wherein
said optical unit is made of a thin film formed on a photographic subject side surface of said photographic optical system.
